(19) United States
(12) Patent Application Publication
(10) Pub. No.: US 2026/0046341 A1
(43) Pub. Date: Feb. 12, 2026

(54) SYSTEMS AND METHODS FOR NORMALIZING USER ENGAGEMENT METRICS

(71) Applicant: 8pod, Inc., Owings Mills, MD (US)

(72) Inventors: Robert Ahadizad NEWPORT, Sydney (AU); Jean-Claude ABOUCHAR, Sydney (AU); Adrian STEIRN, Dubai (AE)

(21) Appl. No.: 19/295,354

(22) Filed: Aug. 8, 2025

Related U.S. Application Data
(60) Provisional application No. 63/681,411, filed on Aug. 9, 2024.
(60) Provisional application No. 63/681,399, filed on Aug. 9, 2024.

(51) Int. Cl. H04L 67/50

(52) U.S. Cl. CPC H04L 67/535

(57) ABSTRACT

A user interaction system may receive user engagement data including data related to a user's interaction with media content. The user interaction system may translate the user engagement data into a time based engagement waveform. The user interaction system may perform signal processing to extract one or more features from the engagement waveform to obtain a user engagement feature set. The user interaction system may provide the user engagement feature set to a machine learning algorithm for predicting user behavior.

### FIELD OF THE INVENTION

The present disclosure is related to systems and methods for normalizing user engagement metrics. In particular, the present disclosure relates to systems and methods to improve the functioning of computational technologies related to artificial intelligence and machine learning models by normalizing otherwise irregular user engagement data into temporal features for machine learning input.

### BACKGROUND OF THE INVENTION

Artificial intelligence systems, including those employing machine learning and deep learning techniques, have seen widespread adoption across a variety of technological domains, including predictive modeling, natural language processing, computer vision, recommendation systems, robotics, and autonomous control. A key characteristic of such systems is their reliance on large volumes of data during training in order to accurately model complex patterns, relationships, and behaviors. The effectiveness of AI models, particularly those involving deep neural networks or transformer-based architectures, may depend heavily on the quantity, diversity, and quality of the data used to train them. Insufficient or biased training data may lead to underfitting, overfitting, or systematic inaccuracies in model predictions. Further, recent advancements in large-scale models, such as foundation models or large language models (LLMs), have further amplified the demand for massive datasets, often including hundreds of billions of data points or tokens.

Additionally, AI models may require that input data conform to standardized formats and structures to enable effective training and inference. However, some real-world data sources may be irregular, unstructured, noisy, or heterogeneous. To make such data suitable for AI processing, it may be necessary to apply pre-processing techniques such as normalization and tokenization. Normalization may involve transforming raw data into a consistent scale or representation, thereby reducing variance that is not meaningful for modeling purposes. Tokenization or normalization may involve segmenting the input into discrete, model-interpretable units using rule-based, statistical, or learned algorithms. Such pre-processing steps may be significant for maximizing the representational efficiency of the data and for improving the performance, generalizability, and robustness of downstream AI models.

Accordingly, there exists a continuing need for systems, methods, and infrastructures that facilitate the efficient acquisition, preparation, management, and normalization of large datasets to support the training, evaluation, and deployment of high-performance AI models.

### SUMMARY OF THE INVENTION

### Brief Description of the Figures

FIG. 1 illustrates architecture for a system for normalizing user engagement data.

FIG. 2 illustrates an user interaction system consistent with embodiments hereof.

FIG. 3 illustrates a method of normalizing user engagement data consistent with embodiments hereof.

### DETAILED DESCRIPTION OF THE INVENTION

The present disclosure provides systems and computer implemented methods for normalizing user engagement data into temporal feature sets for machine learning input. In particular, the systems and methods described herein serve to improve the functionality of computers and computer hardware that implements AI systems and machine learning models. The functionality may be improved by providing data that can be processed more efficiently, thereby providing faster and more accurate results.

As used herein, “media” refers to any digital content that a user may interact with, engage with, consume, view, listen to, manipulate, or otherwise experience. Media may include, but is not limited to, videos, audio clips, music, software applications, web pages, social media platforms or applications, virtual reality (VR) content, augmented reality (AR) content, movies, television shows, video games, podcasts, livestreams, digital books or publications, images, animations, interactive tutorials, user-generated content, advertisements, data visualizations, or any other form of electronically accessible content, whether streamed, downloaded, or rendered in real time on a client or server device.

User engagement data is an example of a real-world data source that may be irregular, unstructured, noisy, and/or heterogeneous. User engagement data may include, for example but not limited to, information representing user interaction with any device configured to capture user input. User engagement data may include user choice data representative of choices, selections, scrolls, clicks, etc., corresponding to user interaction with media, such as videos, audio clips, application interfaces, etc. via any means of user input. User choice data may refer to the active engagement of a user with the interface choices provided by the media, including, for example, selection of media to watch, opting to provide comments or feedback to media, the use of “likes” or emojis to interact with media, and any other form of active intentioned user engagement. User engagement data may further include user activity data, representative of mechanical user activity and interaction with any means of user input, including, but not limited to, keyboard, mouse, touchscreen, virtual touchscreen, voice input device, camera or other sensor for gesture detection, and others. While user choice data may include data representative of user interaction with the media (e.g., what selections or choices did a user make), user activity data may include data representative of user interaction with a user input device (e.g., how often did a user click a mouse or touch a screen). User choice data may be understood in the context of the media being interacted with while user activity data represents raw activity. User engagement data may further include user passive data, including passive or unintentional user input, such as that provided by biometric monitoring (heart rate, breathing rate, brain activity, temperature, etc.), gaze tracking, muscle and movement tracking, voice analysis, etc. User engagement data may further include timing data correlating the events with temporal flow, both in an absolute sense and in a relative sense related to media being interacted with. Additionally, user engagement data may further include information and data that correlates and aligns user choice data, user activity data, and user passive data with media being accessed at the time such user engaged with particular media. For example, user choice data representing a choice to scroll to new content may include information indicative of timing or an event in the previous content that was navigated away from. Additionally, user engagement data may include various forms of metadata, such as user IDs, session IDs, content types, device characteristics, timestamps, etc.

As used herein, “media” refers to any content that a user may engage or interact with. Such content may include, but is not limited to, for example, websites, social media sites and applications, videos, songs or audio clips, pictures or images, games, advertisements, digital books or publications, live streams, interactive content, augmented reality (AR) or virtual reality (VR) environments, animations, podcasts, or other multimedia experiences. Media may be static, dynamic, or interactive in nature, and may be delivered via any device or platform, including but not limited to computers, smartphones, tablets, smart televisions, wearable devices, or network-connected appliances. In certain embodiments, media may further include machine-generated or AI-generated content, such as synthesized text, voice, or imagery. Media may originate from local storage, remote servers, cloud-based services, peer-to-peer systems, or streaming platforms, and may be accessed in real time or asynchronously.

As discussed above, AI models benefit from normalized or tokenized data that is presented for processing in a uniform and discrete fashion. User engagement data is typically not uniform or discrete. Accordingly, adapting AI models to operate with user engagement data, for example, to predict future user behavior, is a challenging technological problem. The present disclosure provides various solutions to this technological problem by providing rule based systems for normalizing user engagement data into temporal feature based data that includes information related to user activity while retaining the temporal nature of such data. Accordingly, the present disclosure provides a technical solution to the above-described technological problem. The present disclosure serves to improve the functioning of computers and computer hardware operating AI systems by increasing the efficiency and accuracy of such systems through the user engagement data normalization techniques provided herein.

Some methods of packaging user data for machine learning may rely on aggregating discrete events or metrics such as clicks, views, session durations, or time-on-page into static features with no temporal aspects. Such features fail to preserve temporal dynamics and nuanced behavioral patterns that evolve over time. These approaches may struggle to capture fluctuations in engagement, periodicity, or the contextual evolution of user intent, leading to limited predictive power, especially in time-sensitive applications like churn prediction or content recommendation.

In contrast, the present system transforms user engagement into a continuous waveform, enabling the use of advanced signal processing techniques such as Short-Time Fourier Transform (STFT) and envelope detection to extract temporal features like amplitude, frequency, and variability. These features retain the rich time-domain characteristics of user behavior, which are then fed into machine learning algorithms for more accurate behavioral modeling. While signal analysis techniques may be used in domains such as speech or biomedical engineering, their application to behavioral engagement modeling is highly unconventional and not previously deployed in practical systems. As discussed above, because typical user engagement data is either noisy and irregular or overly reduced to static values, signal analysis techniques cannot be successfully used. The integration of digital signal processing methods into the machine learning pipeline for user engagement prediction is a significant engineering advancement, offering improved accuracy, interpretability, and generalizability, and representing an unexpected and non-obvious innovation over conventional feature engineering approaches.

This disclosure presents a novel, signal-processing-based framework that models user engagement as a waveform, extracts temporal features, including but not limited to amplitude, frequency, and variability using statistical methods such as Fourier transformations and envelope detection, and inputs these into AI systems for behavior prediction. These systems and methods offer a significantly improved approach to digital interaction analytics.

The present disclosure provides systems and methods for several aspects of methodologies useful in behavioral analytics or user engagement modelling. First, the use of waveform-based representations of user engagement, where raw behavioral data such as clicks, scrolls, dwell time, and re-engagement events are modelled as continuous time-series signals (e.g., user engagement waveforms), provides a novel technical solution to the technological problems associated with data irregularity. Such waveform based representations may be especially useful when the transformation into waveforms is tailored to specific types of digital interaction data. The translation of a user engagement waveform into a temporal feature sequence (e.g., user engagement feature set), including, for example, average amplitude (engagement intensity), frequency components (interaction tempo), and envelope variability (behavioral consistency), forms a unique method of feature engineering. Additionally, the specific application of Short-Time Fourier Transform (STFT), envelope detection with area under the curve, event-triggered averaging, and other signal processing techniques to behavioral engagement signals, particularly when aligned with event logs from web content platforms, provides a significant improvement in prediction accuracy and/or user modelling. Finally, the full end-to-end methodology of embedding temporal user engagement waveform features into neural network and other machine learning architectures (e.g., recurrent or transformer-based models) to predict discrete user outcomes (e.g., retention, re-engagement, conversion) may provide significant improvements to the technological environment of employing machine learning algorithms to predict user behavior. The combination of signal processing techniques with behavioral prediction models described by the present specification represents an advantageous interdisciplinary innovation.

As used herein, the term “artificial intelligence” (AI) is used to refer to a wide variety of methods and systems, including, but not limited to machine learning algorithms and systems. Suitable machine learning systems and algorithms may include, for example, supervised learning models, unsupervised learning models, reinforcement learning models, deep learning neural network models such as feedforward neural networks (FNNs), convolutional neural networks (CNNs), and recurrent neural networks (RNNs), transformer-based models including at least large language models (LLMs), generative models, hybrid or specialized models, etc.

In signal processing, a waveform may be characterized by several fundamental components that describe its behavior in both time and frequency domains. The magnitude (or amplitude) of a wave refers to the peak value of the signal and represents the signal's strength or power. The frequency of a waveform defines how often the wave oscillates per unit of time, measured in Hertz (Hz), and determines the signal's periodicity. The phase of a waveform indicates the waveform's relative alignment in time, expressed in radians (or degrees), and determines where in a cycle the waveform begins. The wavelength refers to the spatial length of one complete cycle, inversely proportional to the frequency in a given medium, and is crucial in understanding wave propagation. Another important waveform feature is the envelope, which outlines the variations in amplitude over time and may be especially relevant in modulated or non-stationary signals. Additionally, a given waveform may be characterized by many different waves overlaid against one another. Thus, a waveform may be characterized by a plurality of components, each having a different amplitude, frequency, and phase. Together, these components may form the basis for analyzing and manipulating signals in applications such as Fourier analysis, filtering, and modulation.

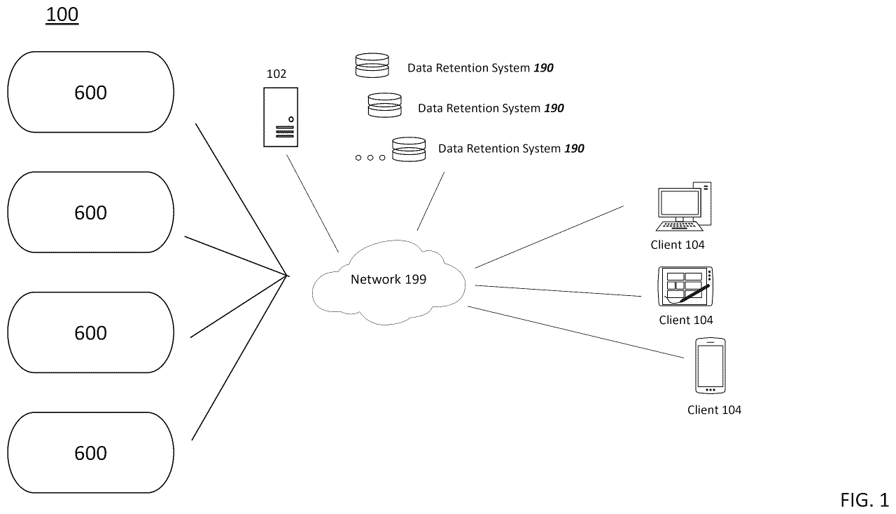

FIG. 1 illustrates a user engagement system according to embodiments hereof. In FIG. 1, an embodiment of a user engagement system 100 and its network environment is depicted. The network environment may include one or more user interaction systems 102 in communication with one or more machine learning algorithms 600, one or more data retention systems 190, and one or more clients 104, via one or more networks 199. The network connections depicted herein may be temporarily or permanently established according to the requirements of the system, as discussed herein. The user engagement system 100 is provided by way of example only. The various functions and roles played by the components discussed herein may be implemented in alternate ways by alternate combinations of systems and hardware without departing from the scope of this invention.

In embodiments, a production framework for executing the user engagement system 100 includes a client-server architecture where user interaction data (e.g., dwell time, clicks, scrolls, hovers, timestamps, etc.) is collected on the client side by client devices 104 running, fore example, web or mobile applications and streamed to a backend system in real time. In some embodiments, the user engagement data may be collected by a media server responsible for providing media content to one or more client devices 104. The backend system, e.g. user interaction system 102, may include a processing pipeline implemented in software using Python or similar, leveraging libraries such as NumPy, SciPy, and PyTorch or TensorFlow. The processing pipeline converts discrete user engagement events into a time-series signal, e.g., a user engagement waveform, applies digital signal processing techniques (e.g., STFT, envelope detection), and extracts temporal features to provide a user engagement feature set. The user engagement features set may then be input into a trained neural network model, e.g., a machine learning algorithm 600, which may, for example, be hosted on a cloud-based inference engine, such as AWS SageMaker, to predict user behavior outcomes. The hardware may include standard cloud infrastructure (e.g., EC2 or GCP instances with CPU/GPU support for training/inference) and optional edge devices for on-device feature extraction in latency-sensitive applications. This modular framework supports scalability, real-time data ingestion, and integration into existing user analytics or recommendation systems.

As used herein, “real-time” refers refers to a level of responsiveness or processing that occurs with a delay that is sufficiently short to enable a system, device, or user to perceive or process results on an on-going basis with respect to triggering events. The precise timing may vary depending on the context and does not require instantaneous operation or zero latency. For example, in the context of real-time data ingestion, “real-time” refers to the ability of the system to receive and process user engagement data while a user continues their engagement, such that there is no or insignificant build-up of unprocessed data. Although there may be latency between user entry and the receipt and processing of the associated user engagement data, the receipt and processing may occur at substantially the same rate (e.g., within 5%, within 3%, within 1%) of the user actions creating the data. Thus, as a user engages with content, their actions are continuously processed as user engagement data in real-time at substantially the same rate that the actions are occurring, even though latency between the two may exist.

The machine learning algorithms 600 illustrated in FIG. 1 may be implemented by one or more computer systems including any of the hardware discussed herein. Suitable machine learning algorithms may include, for example, supervised learning models, unsupervised learning models, reinforcement learning models, deep learning neural network models such as feedforward neural networks (FNNs), convolutional neural networks (CNNs), and recurrent neural networks (RNNs), transformer-based models including at least large language models (LLMs), generative models, hybrid or specialized models, etc. Machine learning algorithms 600 may be adapted to receive data as generated, normalized, and systematized for processing and training by the one or more user interaction systems 102.

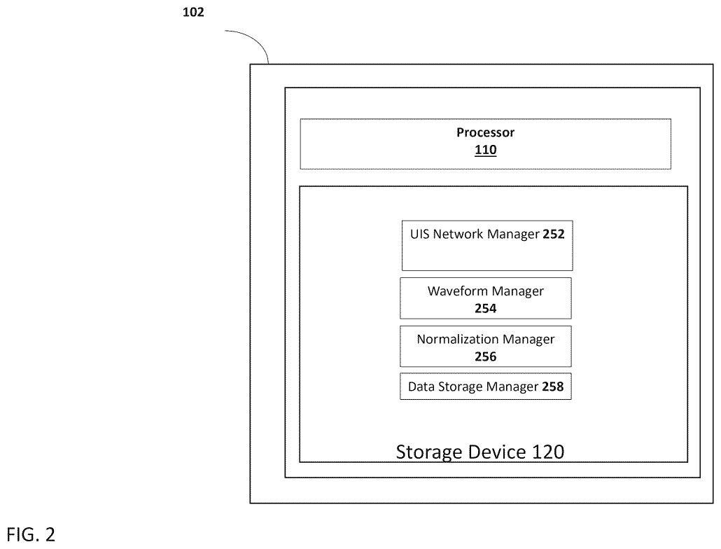

The one or more user interaction systems 102 may be configured as a server (e.g., having one or more server blades, processors, etc.), a personal computer (e.g., a desktop computer, a laptop computer, etc.), a smartphone, a tablet computing device, and/or other device that can be programmed to interface with a computing system implementing a machine learning algorithm. In an embodiment, any or all of the functionality of the one or more user interaction systems 102 may be performed as part of a cloud computing platform. The one or more user interaction systems 102 is further discussed below with respect to FIG. 2. In embodiments, the one or more machine learning algorithm 600 may be implemented by the one or more one or more user interaction systems 102.

The one or more clients 104 may be configured as a personal computer (e.g., a desktop computer, a laptop computer, etc.), a smartphone, a tablet computing device, VR or AR headset, television, and/or other device that can be programmed with a user interface of any type. In embodiments, a wide range of user engagement modes may be modeled as time-based signals, including, but not limited, to website interactions (e.g., page views, click sequences, scroll depth, dwell time), mobile app usage patterns (e.g., screen taps, navigation gestures, session frequency), media consumption behaviors (e.g., video pause/play events, seek patterns, viewing duration), and e-commerce activity (e.g., product browsing, cart additions, checkout steps). In educational platforms (e.g., BBC Maestro), engagement may include quiz attempts, time spent on learning modules, or question response latency. In gaming contexts, user engagement data may capture controller input dynamics, movement patterns, or in-game decision-making frequency. These varied modes of engagement, when encoded as waveforms, enable the system to capture behavioral rhythm, volatility, and sustained interest over time, which traditional event-based logging methods often fail to quantify or leverage effectively for prediction tasks. In embodiments, the one or more user interaction systems 102 and a client 104 may reside within a single system, such as a laptop, desktop, tablet, smartphone, or other computing device with a user interface.

In embodiments, a user may engage with media on a client 104, which may collect user engagement data during the user's media session. As used herein, “session” refers to period in which a user continuously engages with media content. A session may include a period of time in which a user interacts with a social media application, a series of videos, a video game, etc. User engagement data may be collected by the client 104 and/or by a server providing the media content to the user. User engagement data may be collected from the client 104 in real-time, as the user is continuing to engage with the media during a session. User engagement data may also be stored by the client 104 and forwarded to the user interaction system 102 after a session is complete.

The network environment depicted in FIG. 1 represents an example embodiment of a user interaction system 102 configured to receive user engagement data and normalize the user engagement data for consumption by a machine learning algorithm. Although depicted as connected via network 199, any suitable series of individual or network connections may be employed to permit a user interaction system 102 to access required resources such as various data retention systems 190 and exchange data/information with the machine learning algorithms 600 and the client devices 104.

The network 199 may be connected via wired or wireless links. Wired links may include, for example, Digital Subscriber Line (DSL), coaxial cable, Ethernet (e.g., 10/100/1000Base-T, 10 GbE), or optical fiber (e.g., Passive Optical Network (PON), Dense Wavelength Division Multiplexing (DWDM)). Wireless links may include short-range or long-range technologies, such as Bluetooth®, Bluetooth Low Energy (BLE), ANT/ANT+, ZigBee, Z-Wave, Thread, Ultra-Wideband (UWB), Wi-Fi®, including Wi-Fi 5 (802.11ac), Wi-Fi 6/6E (802.11ax), or Wi-Fi 7 (802.11be), as well as Worldwide Interoperability for Microwave Access (WiMAX®), mobile WiMAX®, and WiMAX®-Advanced. Long-range, low-power wireless links may include standards such as SigFox, LoRa, Narrowband IoT (NB-IoT), LTE-M, Random Phase Multiple Access (RPMA), and the Weightless family (Weightless-N/P/W). Additional wireless connectivity options may include Near Field Communication (NFC), infrared (IR), satellite communications (e.g., LEO, MEO, GEO systems), or 5G NR (New Radio), including mmWave and sub-6 GHz bands, as well as emerging 6G technologies under development. Wireless links may further include cellular network standards that qualify as 2G (e.g., GSM), 3G (e.g., UMTS, CDMA2000), 4G (e.g., LTE, LTE-Advanced), or 5G (e.g., standalone or non-standalone 5G NR). Wireless standards may utilize various channel access methods, including, for example, Frequency Division Multiple Access (FDMA), Time Division Multiple Access (TDMA), Code Division Multiple Access (CDMA), Orthogonal Frequency-Division Multiple Access (OFDMA), or Spatial Division Multiple Access (SDMA). In some embodiments, different types of data may be transmitted via different links and standards. In other embodiments, the same types of data may be transmitted redundantly or adaptively via multiple links and standards to optimize performance, resilience, or latency. Network communications may be conducted via any suitable protocol, including, for example, HTTP, HTTPS, TCP/IP, UDP, QUIC, Ethernet, SCTP, or Asynchronous Transfer Mode (ATM).

The network 199 may be any type and/or form of network, including but not limited to a body area network (BAN), a personal area network (PAN), a local area network (LAN), e.g., Intranet, a metropolitan area network (MAN), a wide area network (WAN), or the Internet. The network may also include private or public cloud networks, edge computing networks, fog networks, or hybrid combinations thereof. The topology of the network 199 may be of any form and may include, for example, point-to-point, bus, star, ring, mesh, tree, or hybrid topologies. The network 199 may be capable of supporting centralized, distributed, or decentralized architectures, and may be dynamically reconfigurable. It may include technologies such as software-defined networking (SDN), network function virtualization (NFV), or intent-based networking. The network 199 may utilize different techniques and layered protocol stacks, including, for example, Ethernet, the Internet Protocol suite (TCP/IP), Asynchronous Transfer Mode (ATM), Synchronous Optical Networking (SONET), or Synchronous Digital Hierarchy (SDH). The TCP/IP suite may include the application layer, transport layer (e.g., TCP, UDP, QUIC), internet layer (e.g., IPv4, IPv6), and link layer. The network 199 may be implemented as a broadcast network, a switched network, a telecommunications network, a data communication network, a computer network, or any combination thereof. Network communications may be performed over either unlicensed or licensed frequency bands and may be subject to quality of service (QoS), network slicing, encryption, authentication, or other policies and constraints as necessary to meet application-specific requirements.

The data retention systems 190 may include any type of computer-readable storage medium and/or computer-readable storage device. Such computer-readable storage medium or device may be configured to store and provide access to data and/or instructions for execution by one or more processors. Examples of computer-readable storage media or devices include, but are not limited to, electronic storage devices, magnetic storage devices, optical storage devices, electromagnetic storage devices, or semiconductor-based storage devices, or any suitable combination thereof. Non-limiting examples may include: computer diskettes, hard disk drives (HDD), solid-state drives (SSD), hybrid drives, dynamic random access memory (DRAM), static random access memory (SRAM), synchronous DRAM (SDRAM), double data rate memory (DDR, DDR2, DDR3, DDR4, DDR5), non-volatile memory (NVM) such as NAND flash, NOR flash, magnetoresistive RAM (MRAM), ferroelectric RAM (FeRAM), phase-change memory (PCM), resistive RAM (ReRAM), or other forms of persistent memory. Additional examples may include portable compact disc read-only memory (CD-ROM), digital versatile discs (DVD), Blu-ray discs, memory cards (e.g., SD, microSD), Universal Flash Storage (UFS), embedded MultiMediaCard (eMMC), or USB flash drives. In some embodiments, the storage medium may include remote or distributed storage systems, such as cloud storage, object storage (e.g., Amazon S3, OpenStack Swift), network-attached storage (NAS), or storage area networks (SANs). The storage medium may be implemented using one or more hierarchical storage architectures, tiered memory systems, or content-addressable storage schemes, and may support file-based, block-based, or object-based access protocols.

FIG. 2 illustrates a user interaction system 102 consistent with embodiments hereof. The user interaction system 102 includes one or more processors 110 (also interchangeably referred to herein as processors 110, processor(s) 110, or processor 110 for convenience), one or more storage device(s) 120, and/or other components. In other embodiments, the functionality of the processor may be performed by hardware (e.g., through the use of an application specific integrated circuit (“ASIC”), a programmable gate array (“PGA”), a field programmable gate array (“FPGA”), etc.), or any combination of hardware and software. The storage device 120 includes any type of non-transitory computer readable storage medium (or media) and/or non-transitory computer readable storage device. Such computer readable storage media or devices may store computer readable program instructions for causing a processor to carry out one or more methodologies described here. Examples of the computer readable storage medium or device may include, but is not limited to an electronic storage device, a magnetic storage device, an optical storage device, an electromagnetic storage device, a semiconductor storage device, or any suitable combination thereof, for example, such as a computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, but not limited to only those examples.

The processor 110 is programmed by one or more computer program instructions stored on the storage device 120. For example, the processor 110 is programmed by user interaction system (UIS) network manager 252, a waveform manager 254, a feature extraction manager 256, and a data storage manager 258. It will be understood that the functionality of the various managers as discussed herein is representative and not limiting. Additionally, the storage device 120 may act as a data retention system 190 to provide data storage. As used herein, for convenience, the various “managers” will be described as performing operations, when, in fact, the managers program the processor 110 (and therefore the user interaction system 102) to perform the operation.

The various components of the user interaction system 102 work in concert to provide normalized data to the one or more machine learning algorithms 600. According to embodiments disclosed herein, a waveform derived from user engagement data may be transformed into a set of temporal features and used as input for a neural network or other machine learning algorithm to predict future behaviors, such as content preferences or likelihood of returning. For instance, by segmenting the engagement waveform into fixed time windows, features such as average amplitude (representing intensity of interaction), frequency content (indicating interaction regularity), and temporal patterns (such as bursts or pauses) may be extracted and fed into a recurrent neural network (RNN) or transformer model. These models may learn from sequences of waveform-derived features to identify patterns associated with outcomes like click-through, subscription, or abandonment. For example, a user whose waveform shows frequent high-amplitude spikes followed by rapid declines may indicate initial enthusiasm followed by disinterest, a pattern the machine learning algorithm may learn to associate with low retention probability. In contrast, smoother waveforms with sustained moderate amplitude may correspond to steady, high-quality engagement, which can be predictive of long-term loyalty. This conversion of continuous behavioral signals into structured temporal features allows neural networks to capture nuanced dynamics in user behavior over time and make informed predictions tailored to individual interaction histories.

The UIS network manager 252 is a software protocol operating on the user interaction system 102. The UIS network manager 252 is configured to establish a network communication between the user interaction system 102, machine learning algorithms 600, data retention systems 190, and clients 104. The established communications pathway may utilize any appropriate network transfer protocol and provide for one way or two way data transfer. The UIS network manager 252 may establish as many network communications as required to communicate with one or more machine learning algorithms 600 and with the one or more data retention systems 190 and clients 104. The data and information transferred between the user interaction system 102, the client devices 104, and the machine learning algorithms 600, may include several categories that enable the end-to-end modeling, feature extraction, and prediction of user engagement.

The UIS network manager 252 may facilitate the sending and receiving with the one or more clients 104 of any and all information necessary to carry out the functionality described herein. For example, raw user interaction data is collected from client-side applications operating on the client devices 104 and transmitted to the user interact system 102. The raw user interaction data, e.g., user engagement data, may include timestamped events such as dwell time, clicks, scrolls, hovers, swipes, taps, form submissions, video playback actions, navigation paths, and any other data indicative of a user's interaction with media. These raw events are converted into structured time-series data, e.g., user engagement waveforms, representing engagement over time, as discussed below with respect to the waveform manager 254. The user engagement waveforms may include engagement intensity per unit time, derived behavioral signals, and other information and data discussed herein. The user engagement waveforms are passed to the feature extraction manager 256, which may user signal processing techniques to produce intermediate data outputs, e.g., user engagement feature sets, that include, for example, frequency spectra (via STFT), amplitude envelopes, and statistical measures of variability, continuity, or periodicity.

The UIS network manager 252 allows for the sending and receiving, with one or more machine learning algorithms 600 of any and all information necessary to carry out the functionality described herein. For example, the extracted temporal user engagement feature set or sets, including, for example, numerical descriptors of engagement dynamics are formatted as feature vectors and transferred to the machine learning algorithms 600. Additionally, contextual metadata such as user IDs, session IDs, content types, device characteristics, and timestamps may be transmitted alongside to enhance personalization and prediction accuracy. In return, the user interaction system 102 may receive the predicted outputs from the machine learning algorithm(s) 600, such as likelihood scores for additional dwell time, churn, conversion, content interest, or dropout. These predicted outputs may also be sent by the user interaction system 102 or directly by the machine learning algorithms 600 to downstream systems (e.g., recommendation engines, alerting services, or adaptive interfaces) to drive real-time or pre-processed user experience optimization.

The UIS network manager 252 may be configured to provide a user engagement feature set (as generated by the feature extraction manager 256, discussed below) to one or more machine learning algorithms 600. The production of a user engagement feature set or sets is discussed in greater detail below.

The UIS network manager 252 further facilitates the sending and receiving of, with one or more clients 104, data and information related to user engagement, e.g., user engagement data, including user choice data, user activity data, and user passive data. Such information may include data related to clicks, scrolls, video plays, swipes, eye movement, and any additional information that may be representative of a user's interaction with an application, website, video, etc. Additional examples of user engagement data may include biometric and sensor-based inputs such as eye-tracking coordinates, blink rate, facial expression changes, and device orientation or acceleration (from gyroscopes or accelerometers), particularly relevant in mobile and AR/VR contexts. Further examples include voice commands, speech tempo, and audio response timing can also serve as engagement indicators in voice-activated systems. Further examples include keystroke dynamics such as typing speed, keypress duration, and error rates provide insight into user focus and intent, especially in productivity or coding environments. In collaborative platforms, data such as comment frequency, document editing intervals, and real-time co-authoring activity offer signals of engagement intensity and interaction style may be considered user engagement data. Further examples include notifications received and acted upon (or ignored), time to first action, and multitasking behavior (e.g., switching between tabs or apps). These further examples may enrich the behavioral signal and offer deeper temporal patterns for modeling user attention, engagement decay, or decision-making readiness. The UIS network manager 252 further facilitates the sending and receiving of archival data to one or more data retention systems 190.

The waveform manager 254 is a software protocol operating on the user interaction system 102. The waveform manager 254 is configured to translate user engagement data and/or information into one or more engagement waveforms to model user engagement. This signal-based abstraction may allow for the application of signal processing techniques to model, analyze, and predict engagement dynamics across time, thus revealing underlying behavioral patterns and helping to optimize content delivery strategies. User engagement data, which is typically irregular, unstructured, noisy, and/or heterogeneous in nature, may be translated into one or more engagement waveforms. Subsequently, the engagement waveforms may be further analyzed, e.g., by the feature extraction manager 256, using signal processing techniques that would otherwise be inapplicable to user engagement data. A waveform may be used to model a user's engagement with entertainment content, e.g., media, on a website or within an application by mapping temporal fluctuations in behavior into signal features that reflect attention and interest levels.

In embodiments, translating the user engagement data into an engagement waveform may include selecting a waveform amplitude corresponding to an intensity of user interaction. For example, the magnitude of the waveform may correspond to the intensity of engagement at a given moment, where higher peaks indicate a higher degree of active interaction, such as clicks, scrolls, or video plays while lower amplitude values may signify passive consumption or inactivity. User choice data indicative of engagement intensity may include information indicating a high degree of activity and interaction with media, for example, a user making many selections or choices in a short period of time, indicating active engagement. User passive data indicative of engagement intensity may include biometric information indicative of greater engagement, such as a raised heartbeat or increased eye gaze activity. User activity data indicative of engagement intensity may include raw mechanical data indicating a heightened degree of user input activity. In embodiments, user engagement intensity and a waveform magnitude may be based on an amount of user engagement within an engagement interval. An engagement interval may be a narrow interval of time during which a user's engagement activity is sampled and may refer to a sampling window that is less than 5 seconds, less than 3 seconds, less than 1 second, less than 0.5 seconds, less than 0.1 seconds, etc. Thus, an amount of activity within a specific engagement interval may be represented by waveform amplitude. In some embodiments, engagement intervals may be a time unit as small as practical within the context of the relevant processing system.

In embodiments, translating the user engagement data into an engagement waveform may include selecting a waveform frequency corresponding to a rate of user interaction. As used herein, rate of user interaction refers to how often user interaction occurs. In an embodiment, rate of user interaction may refer to a rate at which engagement intervals include any amount of user activity. In embodiments, user engagement frequency and thus a waveform frequency may be based on a rate at which engagement intervals indicate user activity. The frequency of the engagement waveform may represent how often a user interacts with the media within a certain period, with more frequent oscillations, e.g., a higher frequency, indicating a high tempo of engagement, e.g., many engagement intervals within an extended period demonstrate user activity. User choice data indicative of engagement rate may include information indicating a high frequency of activity and interaction with media, for example, a user making many selections or choices over an extended period of time, indicating lengthy active engagement. User passive data indicative of engagement rate may include biometric information indicative of frequent engagement, such as frequent changes in biometric data. User activity data indicative of engagement rate may include raw mechanical data indicating regular user input activity across a length of time.

In embodiments, translating the user engagement data into an engagement waveform may include selecting a waveform phase corresponding to a timing of user interaction. In an embodiment, phase may be used to align multiple users' engagement patterns. For example, if user engagement data corresponding to a plurality of users' activities (rate and intensity) are used to construct waveforms (frequency and amplitude), these waveforms may be overlaid on one another to represent the activity of multiple users in a single engagement waveform. The phase of the individual components of these waveforms may be representative of the timing of interaction of the different users. The phase of the engagement waveforms may be used to align the waveform representing each user's activities with specific timing corresponding to the media with which they engaged. Thus, the timing of waveform peaks may be correlated with specific events or other moments in the media. In embodiments, the phase of the engagement waveform may thus be used to capture when in a session key behaviors occur relative to one another. Phase may be used in this manner whether the user engagement waveform represents that interactions of one or many users.

In embodiments, translating the user engagement data into an engagement waveform may include selecting a width of a waveform peak according to a dwell time of a user interaction. Dwell time may be defined as the duration a user spends on a piece of content or with a specific aspect of media. The engagement waveform may include wider peaks for longer dwell times. In embodiments, the engagement waveform may include a series of peaks representative of longer dwell times. In embodiments, re-engagement over time with a specific media aspect of piece of content may be represented in the engagement waveform by recurring bursts of high frequency activity within the waveform separated by periods of lower activity, indicating return visits or renewed interest.

The feature extraction manager 256 is a software protocol operating on the user interaction system 102. The feature extraction manager 256 is configured to extract features from the user engagement waveform to generate a user engagement feature set. This process may result in the normalization, discretization, and/or systematization of the user engagement waveform to generate a set of features, e.g., the user engagement feature set, that may be suitable for input to a machine learning algorithm. As used herein, “feature extraction” refers to the process of analyzing a signal to compute derived characteristics, metrics, or descriptors that represent informative aspects of the waveform for use in downstream processing, classification, or decision-making. Feature extraction may include generating a set of features that characterize the user engagement waveform, where each feature corresponds to a time window of the user engagement waveform. The features and corresponding time window information may be referred to as a user engagement feature set. Translating a signal-based abstraction of user engagement (e.g., a user engagement waveform) into measurable metrics (e.g., a user engagement feature set) may involve applying signal processing and behavioral analysis techniques to the time-series data captured during user interactions.

In embodiments, the set of features includes a plurality of features. Each feature may correspond to a time window of the user engagement waveform. The time windows may be at least as long as an engagement interval. The size of the time windows may be selected so as to include a plurality of engagement intervals, e.g., 2, 10, 50, 100, or any other suitable number. The size of the time windows may be selected so as to include an integer number of engagement intervals, e.g., the length of the time window may be an integer number of times larger than an engagement interval. In embodiments, the time windows may be selected to overlap or may be selected as non-overlapping. Non-overlapping time windows may be selected such that they are adjacent to one another with no gaps.

The features may be numerical or quantified representations characterizing the engagement waveform within their corresponding time windows. In embodiments, features may include scalar, vector, or array based representations. In an embodiment, scalar feature values may include values representative of amplitude, frequency, and/or phase. In embodiments, features may include vectors, for example, a vector representing amplitude, frequency, and waveform variability. Features may further include expressions representative of waveform envelope, area under curve, and other suitable waveform characterizations. Features may further include any suitable time domain features (e.g., DC offset, rise time, fall time, peak, peak-to-peak amplitude, zero-crossing rate, duty cycle, skewness, kurtosis, duration, pulse width, etc.), frequency domain features (e.g., spectral centroid, bandwidth, spectral flatness, spectral roll-off, harmonic content, etc.), energy features (power, root mean square, signal to noise ratio, etc.), as well as features related to a waveform patterns (e.g., waveform slope, turning points, inflection points, complexity, modulation characteristics, etc.)

Extracting features from the engagement waveform may include any type of signal processing or other analysis technique that may serve to discretize, digitize, normalize, etc. a waveform into a set of features as described above. In embodiments, normalizing the engagement waveform may be a lossless procedure that preserves all information in the engagement waveform, permitting the engagement waveform to be fully recreated from the set of features. In embodiments, normalizing the engagement waveform may involve one or more steps or procedures that are lossy and do not preserve all waveform information.

In embodiments, extracting features from the engagement waveform may include time-frequency analysis using Fourier Transforms, such as a Short-Time Fourier Transform (STFT): This method may segment the user engagement waveform into overlapping time windows. A Fourier Transform may be applied to each window to capture the spectral content of each window. The spectral content may be observed across multiple time windows to determine how the spectral content evolves over time. For example, repeated user interactions, such as clicks or scrolls, may manifest as bursts of high-frequency components, while longer periods of passive dwell time may appear as low-frequency regions. STFT may enable the detection of periodic engagement behaviors, which can be used to inform content timing strategies or to identify habitual re-engagement patterns. This may be particularly useful when user behavior varies across different time scales.

In an embodiment, extracting features from the engagement waveform may include envelope detection and/or area under curve (AUC) calculations. Envelope detection smooths the engagement signal to outline its overall amplitude variation over time. The resulting envelope may be integrated (using AUC) to provide a single scalar value representing the total engagement effort over an engagement session or across sessions. Further, area under the curve calculations may be applied across different periods of time within a given session, e.g., 1, 5, 10, 20, 50, or 100 time windows, or any other suitable number. A higher AUC may reflect not just long dwell times but also frequent and intense interactions. This approach may capture cumulative engagement over a specified period and may and allow for comparison between users or content types. AUC computations may be useful in assessing the overall “energy” or impact of content engagement.

In an embodiment, extracting features from the engagement waveform may include event-Triggered Averaging (ETA). In ETA, engagement signals may be aligned based on the occurrence of a specific event—such as starting a video, clicking a “like” button, or returning to the page—and averaged across multiple users or sessions. The system may identify a point in time of the specific event occurring in multiple different user engagement waveforms. In embodiments, the system may identify the point in time as a particular engagement interval or as a particular time window. The engagement waveform may be segmented using the timing of the event as a point of reference. A segmented portion of the engagement waveform may include a specified number of time windows or engagement intervals before the event and a specified number after the event. Segments from the engagement waveforms of multiple different users may be aligned using the event as a point of reference. In embodiments, a mean or average engagement waveform may be produced by pointwise averaging together all of the different segments. This technique may help extract a canonical waveform segment that reflects typical behavioral response around specific event. ETA may reveal patterns such as whether engagement tends to spike just before or after a specific action and may be used to optimize design elements that prompt re-engagement. Event triggered averaging may be employed with other signal processing techniques to normalize the canonical waveform segment by features and time windows, as discussed above.

In embodiments, extracting features from a user engagement waveform may be performed as follows. Let x(t) represent a continuous user engagement waveform encoding user engagement over time, as discussed above. The user engagement waveform may be segmented into N fixed-length time windows of duration Δt, producing segments xₙ(t) for n=1, 2, . . . , N. For each segment, a feature may be determined, for example a feature vector fₙ=[Aₙ, Fₙ, Vₙ], where

$${A}_{n} = \frac{1}{Δ t} {\int }_{{t}_{n}}^{{t}_{n} + Δ t} \vert {x}_{n} ( t ) \vert dt$$

is the average amplitude (or intensity), Fn=arg max |F[xₙ(t)]| is the dominant frequency component obtained via a Fourier Transform, and Vₙ is a variability metric such as the standard deviation of xₙ(t). The sequence of feature vectors {f1, f2, . . . , f_{N}} represents a user engagement feature set or sets and may form the input to a neural network model M (an example of a machine learning algorithm 600), such as an RNN model or transformer model, which may output a predicted behavior label

$$\hat{y} = M ( {\{ {f}_{n} \}}_{n}^{N} = 1 ) .$$

The feature extraction manager 256 and the UIS network manager 252 may operate in conjunction to generate the normalized user engagement feature set (e.g., sequence of feature vectors) and provide such to the one or more machine learning algorithms 600.

This mathematical formulation captures an example of the process of transforming a raw user engagement waveform into structured temporal features. By extracting average intensity, dominant frequency, and variability from each segment, the temporal dynamics of user behavior can be provided in a form that machine learning algorithms can process to learn patterns and predict outcomes like engagement level, content affinity, probability of re-engagement, etc.

The diverse user engagement data described herein is transformed into time-series representations, e.g., user engagement waveforms, and processed using digital signal processing techniques to extract temporal feature sets, e.g., user engagement feature sets, that retain behavioral structure across time. These features, such as dwell time, engagement frequency, amplitude (intensity), rhythm, and volatility, may serve as input to machine learning algorithms that are trained to predict specific user behaviors. During training, historical interaction data with known outcomes (e.g., whether a user dwelled, churned, clicked a recommendation, completed a task, or made a purchase) is used to supervise the learning process. Neural network and machine learning architectures well-suited to temporal data, such as recurrent neural networks (RNNs), Long Short-Term Memory networks (LSTMs), or Transformer-based models (LLMs), are trained on user engagement feature sets using loss functions aligned to the prediction task (e.g., binary cross-entropy for classification, mean squared error for regression, etc.). The models may learn complex temporal dependencies and behavioral signatures that are predictive of future outcomes. A practical use case of this technique is in adaptive content recommendation. By modeling a user's interaction signal over time, the system can predict moments of heightened engagement or disengagement and adjust content delivery accordingly, e.g., as surfacing high-relevance material during attention peaks or delaying prompts during periods of inactivity. This results in a more personalized and responsive user experience.

The foregoing provides several example signal processing techniques and how they may be applied in the context of normalizing user engagement waveforms to extract features and generate user engagement feature sets. These example are by way of example only and are non-limiting. Any suitable signal processing technique may be employed to normalize a user engagement waveform into the features and time window information necessary for a user engagement feature set. For example, such further techniques may include convolution, correlation, cross-correlation, autocorrelation, moving average filtering, Savitzky-Golay filtering, zero-crossing analysis, wavelet transforms, cepstral analysis, power spectral density (PSD), Hilbert transforms, spectrograms, low-pass filtering, high-pass filtering, band-pass filtering, band-stop filtering, FIR filtering, IIR filtering, adaptive filtering, notch filtering, principal component analysis (PCA), independent component analysis (ICA), blind source separation (BSS), empirical mode decomposition (EMD), nonlinear energy operator (NEO), Teager-Kaiser energy operator, synchrosqueezing transforms, matching pursuit, feature extraction, Shannon entropy, sample entropy, approximate entropy, fractal dimension, Hurst exponent, Kalman filtering, spike-triggered averaging, time-warping (e.g., dynamic time warping), peak detection, onset detection, envelope correlation, etc.

The data storage manager 256 is a software protocol operating on the user interaction system 102. The data storage manager 256 is configured to facilitate access to one or more data retention systems 190 to store and/or receive user engagement data and user engagement waveforms stored in the data retention system 190.

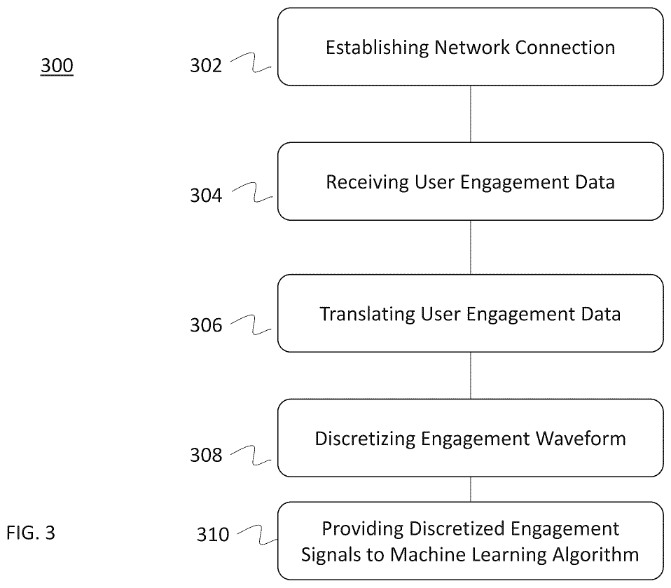

FIG. 3 is a flow chart showing a process 300 of normalizing user engagement data for machine learning processing. The process 300 is performed on a computer system having one or more physical processors programmed with computer program instructions that, when executed by the one or more physical processors, cause the computer system to perform the method. The one or more physical processors are referred to below as simply the processor. In embodiments, the process 300 is carried out via the user interaction system 102 in communication with one or more machine learning algorithms 600 and one or more user devices 104, as described herein. The user interaction system 102 represents an example of a hardware and software combination configured to carry out process 300, but implementations of the process 300 are not limited to the hardware and software combination of the user interaction system 102. Additional details regarding each of the operations of the method may be understood according to the description the user interaction system 102, as described above.

In an operation 302, process 300 includes establishing a network connection. A network connection may be established between a user interaction system as described herein, client devices, and/or machine learning algorithms may be established via any suitable network transmission protocol or protocol suite, including, e.g., http, TCP/IP, LAN, WAN, WiFi, etc. In embodiments, the network connection may be established according to the functionality of the UIS network manager 252, as described above.

In an operation 304, process 300 includes receiving or otherwise obtaining user engagement data. The user engagement data may be received from one or more client devices, either directly or indirectly. The user engagement data may be received in real time, e.g., during a user interaction, and/or may be received as a data log or other data storage type. In embodiments, an intermediary server may be configured to receive, collect, and/or store user engagement data for later receipt by a user interaction system. In embodiments, the user engagement data may have been previously stored on a storage device of the user interaction system and/or on a data retention device or system or other data storage device accessible by the user interaction system. Receiving or obtaining the user engagement data may be accomplished over the network connection and may be facilitated by a UIS network manager and/or a data storage manager.

In an operation 306, process 300 includes translating user engagement data into a user engagement waveform. Translating user engagement data into a user engagement waveform may involve the generation of waveforms having characteristics determined by the user engagement data. Translating the user engagement data may be performed, for example, by a waveform manager of a user interaction system, such as described above with respect to the waveform manager 254.

In an operation 308, process 300 includes normalizing the user engagement waveform into user engagement feature sets by extracting features from the user engagement waveform. Processing the user engagement waveform (or waveforms) to obtain normalized user engagement feature sets may be performed by segmenting the user engagement waveform according to a series of time windows. Each segment may then be characterized by one or more features, such as a feature vector or matrix. The features may be generated according to one or more signal processing techniques. The series of features and time window information may constitute the normalized user engagement feature sets. As described above, processing the user engagement waveform to obtain the user engagement feature sets may be performed by a feature extraction manager, e.g., feature extraction manager 256.

In an operation 310, process 300 includes providing the user engagement feature sets to a machine learning algorithm. Subsequent to normalization, the user engagement feature sets, e.g., feature and time window information, may be provided to one or more machine learning algorithm. The normalized user engagement feature sets may be provided to machine learning algorithms for training purposes and/or for user behavior prediction purposes. The process of providing such information to a machine learning algorithm is described in greater detail above.

In embodiments, a pipeline of the user interaction system may include continuous translation of user engagement data into user engagement waveforms and continuous processing of the user engagement waveforms to extract features to generate user engagement feature sets. By continuous, it is meant that user engagement data may be translated into one or more user engagement waveform at the same time as the user engagement data is still being obtained, e.g., in real time. Thus, data obtained from a user's interactions may be continuously translated into user engagement waveforms during the user's continued interaction with a media product, e.g., during a session. Similarly, the user engagement waveforms may be continuously processed to obtain user engagement feature sets. The user engagement feature sets may, in turn, be continuously processed by a machine learning algorithm to obtain user behavior predictions. Thus, as used herein, continuous processing refers to employing the user engagement processing methods described above during a user's ongoing media interaction session. Such continuous processing may have the benefit of generating user behavior prediction information while a user is still interacting with particular media, e.g., during a same session. Such user prediction information may be employed, for example, to adjust or otherwise tailor a user's media experience according to their ongoing engagement.

It will be readily apparent to one of ordinary skill in the relevant arts that other suitable modifications and adaptations to the methods and applications described herein can be made without departing from the scope of any of the embodiments.

It is to be understood that while certain embodiments have been illustrated and described herein, the claims are not to be limited to the specific forms or arrangement of parts described and shown. In the specification, there have been disclosed illustrative embodiments and, although specific terms are employed, they are used in a generic and descriptive sense only and not for purposes of limitation. Modifications and variations of the embodiments are possible in light of the above teachings. It is therefore to be understood that the embodiments may be practiced otherwise than as specifically described.

All publications, patents and patent applications mentioned in this specification are herein incorporated by reference to the same extent as if each individual publication, patent or patent application was specifically and individually indicated to be incorporated by reference.

1. A system for predicting user behavior, comprising at least one processor and a computer memory, the at least one processor being configured for:
receiving user engagement data;
translating the user engagement data into an engagement waveform;
extracting one or more features from the engagement waveform to obtain a user engagement feature set; and
providing the user engagement feature set to a machine learning algorithm.

2. The system of claim 1, wherein user engagement data includes one or more of clicks, scrolls, or user inputs.

3. The system of claim 1, wherein translating the user engagement data into an engagement waveform includes selecting a waveform frequency corresponding to a frequency of user interaction.

4. The system of claim 1, wherein translating the user engagement data into an engagement waveform includes selecting a waveform amplitude corresponding to an intensity of user interaction.

5. The system of claim 1, wherein translating the user engagement data into an engagement waveform includes translating user engagement data corresponding to a plurality of users into the engagement waveform.

6. The system of claim 1, wherein translating the user engagement data into an engagement waveform includes selecting a phase value corresponding to timing of user interaction.

7. The system of claim 1, wherein extracting the one or more features includes:
segmenting the engagement waveform into a plurality of time windows, wherein the time windows overlap; and
applying a Fourier transform to the plurality of time windows.

8. The system of claim 1, wherein extracting the one or more features includes:
detecting an envelope of the engagement waveform; and
determining an area under curve for the envelope of the engagement waveform.

9. The system of claim 1, wherein extracting the one or more features includes:
performing event triggered averaging on the engagement waveform.

10. The system of claim 1, wherein extracting the one or more features includes:
segmenting the engagement waveform into a plurality of time windows, wherein the time windows overlap; and
determining the user engagement feature set as a plurality of feature vectors, each corresponding a time window of the plurality of time windows, representative of amplitude, frequency, and variability within the time window.

11. A method for predicting user behavior, executed by at least one processor, the method comprising:
receiving user engagement data;
translating the user engagement data into an engagement waveform;
extracting one or more features from the engagement waveform to obtain a user engagement feature set; and
providing the user engagement feature set to a machine learning algorithm.

12. The method of claim 11, wherein user engagement data includes one or more of clicks, scrolls, or user inputs.

13. The method of claim 11, wherein translating the user engagement data into an engagement waveform includes selecting a waveform frequency corresponding to a frequency of user interaction.

14. The method of claim 11, wherein translating the user engagement data into an engagement waveform includes selecting a waveform amplitude corresponding to an intensity of user interaction.

15. The method of claim 11, wherein translating the user engagement data into an engagement waveform includes translating user engagement data corresponding to a plurality of users into the engagement waveform.

16. The method of claim 11, wherein translating the user engagement data into an engagement waveform includes selecting a phase value corresponding to timing of user interaction.

17. The method of claim 11, wherein extracting the one or more features includes:
segmenting the engagement waveform into a plurality of time windows, wherein the time windows overlap; and
applying a Fourier transform to the plurality of time windows.

18. The method of claim 11, wherein extracting the one or more features includes:
detecting an envelope of the engagement waveform; and
determining an area under curve for the envelope of the engagement waveform.

19. The method of claim 11, wherein extracting the one or more features includes:
performing event triggered averaging on the engagement waveform.

20. The method of claim 11, wherein extracting the one or more features includes:
segmenting the engagement waveform into a plurality of time windows, wherein the time windows overlap; and
determining the user engagement feature set as a plurality of feature vectors, each corresponding a time window of the plurality of time windows, representative of amplitude, frequency, and variability within the time window.
